(19) United States
(12) Patent Application Publication
(10) Pub. No.: US 2025/0232401 A1
(43) Pub. Date: Jul. 17, 2025

(54) METHOD, DEVICE, AND COMPUTER PROGRAM PRODUCT FOR GENERATING SUPER RESOLUTION IMAGE

(71) Applicant: Dell Products L.P., Round Rock, TX (US)

(72) Inventors: Zhisong Liu, Shenzhen (CN); Zijia Wang, Weifang (CN); Zhen Jia, Shanghai (CN)

(21) Appl. No.: 18/432,169

(22) Filed: Feb. 5, 2024

(30) Foreign Application Priority Data
Jan. 12, 2024 (CN) 202410051905.5

(51) Int. Cl. G06T 3/4053; G06T 3/4046

(52) U.S. Cl. CPC G06T 3/4053; G06T 3/4046

(57) ABSTRACT

The present disclosure relates to a method, a device, and a computer program product for generating a super resolution image. The method includes: generating, by a first network and based on a first image of first resolution, a second image of first super resolution; determining, by the first network, a first residual image based on the first image and the second image; and generating, by a second network, a third image of second super resolution based on the first residual image and the second image, wherein the first super resolution is higher than the first resolution and the second super resolution is higher than the first super resolution. In this way, the data fidelity can be maintained and the signal-to-noise ratio can be reduced when generating high resolution images, thereby improving the image quality.

### RELATED APPLICATION

The present application claims priority to Chinese Patent Application No. 202410051905.5, filed Jan. 12, 2024, and entitled “Method, Device, and Computer Program Product for Generating Super Resolution Image,” which is incorporated by reference herein in its entirety.

### FIELD

The present disclosure relates to the field of artificial intelligence and, more specifically, to a method, a device, and a computer program product for generating a super resolution image.

### BACKGROUND

Today, there have been great advances in digital display devices. Many display devices can support 4K or even 8K video/images, such as file screens, billboards, and others. With the rapid development of hardware, effective tools for digital signal compression, transmission, and restoration are desired. For a given large device used to capture megapixel or even gigapixel images, it is desired to effectively transmit and store these image pixels with lossless or lossy restoration.

In this context, image/video super resolution schemes are proposed for up-sampling the source data to a much larger resolution or frames per second (FPS). Image/video super resolution schemes can alleviate the burden of data storage and transmission, thereby reducing the risk of data corruption and loss. However, the existing image/video super resolution methods are typically based on fixed up-sampling, which may lead to blurring effects when scaling the source image data to a much larger scale. This is a significant problem, especially for fields such as medicine and architecture where high data fidelity is required.

### SUMMARY

Embodiments of the present disclosure provide a method, a device, and a computer program product for generating a super resolution image.

In one aspect of the present disclosure, a method for generating a super resolution image is provided. The method includes: generating, by a first network and based on a first image of first resolution, a second image of first super resolution; determining, by the first network, a first residual image based on the first image and the second image; and generating, by a second network, a third image of second super resolution based on the first residual image and the second image, wherein the first super resolution is higher than the first resolution and the second super resolution is higher than the first super resolution.

In another aspect of the present disclosure, an electronic device is provided. The electronic device includes at least one processor and a memory, wherein the memory is coupled to the at least one processor and has instructions stored therein. The instructions, when executed by the at least one processor, cause the electronic device to perform actions comprising: generating, by a first network and based on a first image of first resolution, a second image of first super resolution; determining, by the first network, a first residual image based on the first image and the second image; and generating, by a second network, a third image of second super resolution based on the first residual image and the second image, wherein the first super resolution is higher than the first resolution and the second super resolution is higher than the first super resolution.

In yet another aspect of the present disclosure, a computer program product is provided, the computer program product being tangibly stored on a non-transitory computer-readable medium and comprising machine-executable instructions. The machine-executable instructions, when executed by a machine, cause the machine to perform actions comprising: generating, by a first network and based on a first image of first resolution, a second image of first super resolution; determining, by the first network, a first residual image based on the first image and the second image; and generating, by a second network, a third image of second super resolution based on the first residual image and the second image, wherein the first super resolution is higher than the first resolution and the second super resolution is higher than the first super resolution.

It should be understood that the content described in this Summary is neither intended to limit key or essential features of embodiments of the present disclosure, nor intended to limit the scope of the present disclosure. Other features of the present disclosure will become readily understood from additional description provided herein.

### BRIEF DESCRIPTION OF THE DRAWINGS

The above and other features, advantages, and aspects of embodiments of the present disclosure will become more apparent with reference to the accompanying drawings and the following Detailed Description. In the accompanying drawings, identical or similar reference numerals represent identical or similar elements, in which:

FIG. 1 is a schematic diagram of a network architecture for generating a super resolution image according to some embodiments of the present disclosure;

FIG. 2 is a flow chart of a method for generating a super resolution image according to some embodiments of the present disclosure;

FIG. 3 is a flow chart of another method for generating a super resolution image according to some embodiments of the present disclosure;

FIG. 4 is a schematic diagram of a cascaded back projection network according to some embodiments of the present disclosure;

FIG. 5 is a schematic diagram of a model selection module of a cascaded back projection network according to some embodiments of the present disclosure;

FIG. 6 is a schematic diagram of a local implicit image function (LIIF) module and an image ensemble module of a cascaded back projection network according to some embodiments of the present disclosure;

FIG. 7 is a schematic diagram of a back projection process according to some embodiments of the present disclosure;

FIG. 8 is a schematic diagram of an image generated by a network architecture for generating a super resolution image according to some embodiments of the present disclosure;

FIG. 9 is a schematic diagram of classification scores of a model selection module according to some embodiments of the present disclosure; and

FIG. 10 is a block diagram of a device that can implement a plurality of embodiments of the present disclosure.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the scope of protection of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below. Hereinafter, the term “image” may refer to a variety of static images or video frames extracted from a motion video, and thus the present disclosure can be applied to image processing or video processing. Hereinafter, the term “super resolution (SR)” image may refer to an image with a resolution higher than that of the source image, which is obtained by up-sampling the image, and may be used interchangeably with a high resolution (HR) image. Hereinafter, the source image has the lowest resolution compared to the other images, and may therefore be referred to as a low resolution (LR) image. Hereinafter, the terms “feature map,” “depth feature,” and “feature vector” are all related to features of the image and may be used interchangeably.

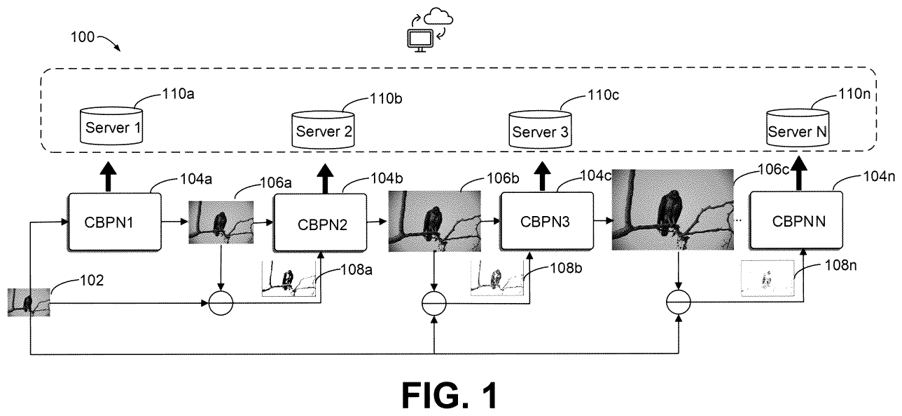

FIG. 1 is a schematic diagram of a network architecture 100 for generating a super resolution image according to some embodiments of the present disclosure. As an example, the network architecture 100 may include a plurality of cascaded back projection networks (CBPNs) CBPN1 104a to CBPNN 104n arranged in a cascade so that the cascaded back projection network architecture may be used for continuous learning, where n is any positive integer. It should be understood that CBPNs are provided herein as an example only and the present disclosure is not limited thereto. In other words, in the network architecture 100 according to the present disclosure, new image data obtained based on each piece of image data can be used to fine-tune the architecture to automatically improve the image quality. In FIG. 1, n residual images 108a-108n may be generated via CBPN1 104a to CBPNN 104n, and CBPN1 104a to CBPNN 104n may correspond to n servers 110a-110n. It should be understood that the numbers of networks, residual images, and servers are provided herein as examples only, and the present disclosure is not limited thereto.

As shown in FIG. 1, the network architecture 100 may include CBPN1 104a to CBPNN 104n arranged in series. The CBPN1 104a may generate a second image 106a of first super resolution based on a first image 102 of first resolution, and may determine a first residual image 108a based on the first image 102 and the second image 106a, the first super resolution being higher than the first resolution. The CBPN2 104b may generate a third image 106b of second super resolution based on the second image 106a and the first residual image 108a, the second super resolution being higher than the first super resolution. In some examples, the first image 102 may correspond to a low resolution image, the second image 106a generates a first super resolution image, and the third image 106b may correspond to a second super resolution image.

In some examples, the first image 102 includes a static image or an image frame extracted from a motion video, wherein the CBPN1 104a is provided on an edge device or a cloud.

In some embodiments, the CBPN2 104b may also determine a second residual image 108b based on the third image 106b and the first image 102, and the CBPN3 104c may generate a fourth image 106c of third super resolution based on the second residual image 108b and the third image 106b, wherein the third super resolution is higher than the second super resolution. In some embodiments, the subsequent CBPNs may iteratively perform the above process until an image of desired resolution is generated.

By the CBPN1 104a generating the second image 106a having the first super resolution higher than the first resolution based on the first image 102 of the first resolution and determining the first residual image 108a based on the first image 102 and the second image 106a, and by the CBPN2 104b generating the third image 106b having the second super resolution higher than the first super resolution based on the second image 106a and the first residual image 108a, the network architecture 100 can achieve super resolution up-sampling while maintaining data fidelity, i.e., minimizing the signal-to-noise ratio (SNR), thereby greatly improving the quality of the generated super resolution image. Moreover, the network architecture 100 is a scalable framework for realizing continuous learning, which can provide more flexibility.

As shown in FIG. 1, the CBPN1 104a to the CBPNN 104n may be provided in the servers 110a-110n, respectively. The servers 110a-110n may all be provided on edge devices or all be provided on a cloud. In some embodiments, the servers 110a-110n may be individually provided on edge devices or on a cloud to iteratively improve the image quality without complex model training and setup. That is, some servers are provided on edge devices while others are provided on a cloud, thus enabling each CBPN to be deployed and trained independently.

It can be understood that the CBPN1 104a to the CBPNN 104n may be the same CBPNs or may be different CBPNs. That is, the CBPN1 104a to the CBPNN 104n may include the same modules or different modules, as long as the CBPN1 104a to the CBPNN 104n may generate an SR image, determine a residual image between the SR image and the LR image, and generate a next SR image based on the SR image and the residual image.

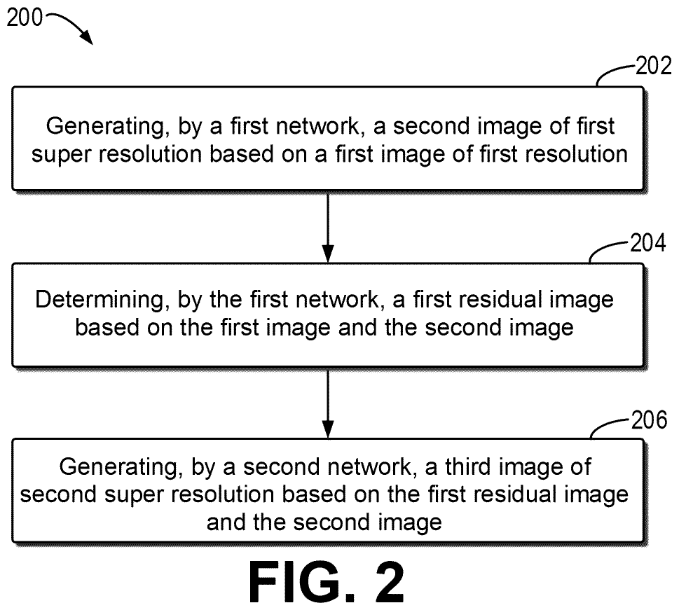

FIG. 2 is a flow chart of a method 200 for generating a super resolution image according to some embodiments of the present disclosure. The method 200 shown in FIG. 2 may be implemented in the network architecture 100 shown in FIG. 1. The method 200 includes: at 202, generating, by a first network, a second image of first super resolution based on a first image of first resolution; at 204, determining, by the first network, a first residual image based on the first image and the second image; and at 206, generating, by a second network, a third image of second super resolution based on the first residual image and the second image, wherein the first super resolution is higher than the first resolution and the second super resolution is higher than the first super resolution.

The method 200, by generating an SR image based on the LR image, determining a residual image based on the SR image and the LR image, and generating the next SR image based on the SR image and the residual image, can increase the image resolution while maintaining the data fidelity, thereby reducing the signal-to-noise ratio, avoiding blurring effects, and improving the image quality.

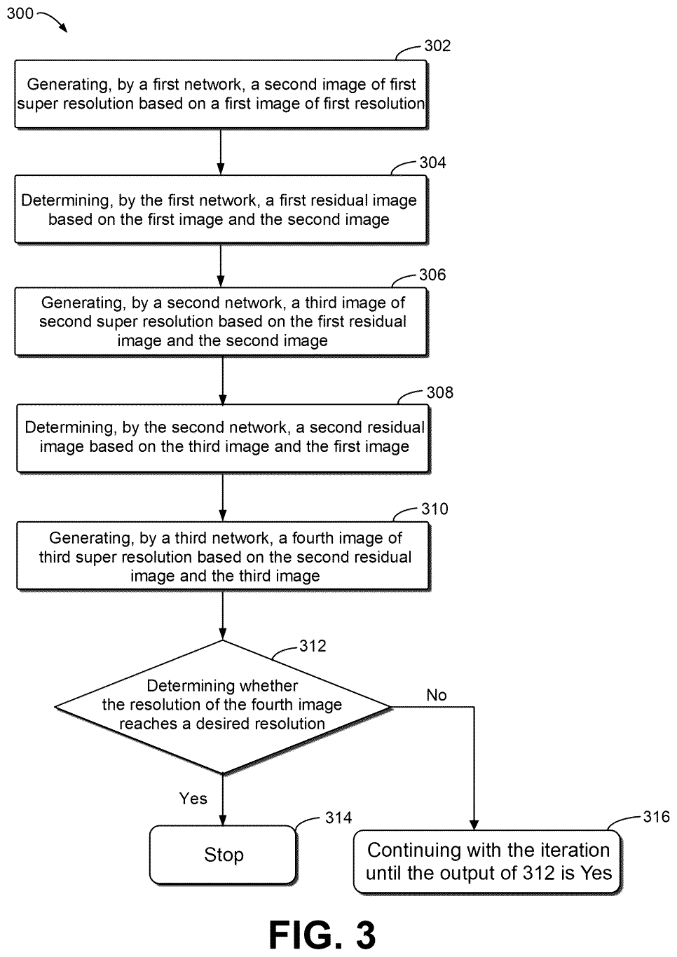

FIG. 3 is a flow chart of another method 300 for generating a super resolution image according to some embodiments of the present disclosure. The method 300 shown in FIG. 3 may be implemented in the network architecture 100 shown in FIG. 1. The method 300 includes: at 302, generating, by a first network, a second image of first super resolution based on a first image of first resolution, wherein the first super resolution is higher than the first resolution; at 304, determining, by the first network, a first residual image based on the first image and the second image; at 306, generating, by a second network, a third image of second super resolution based on the first residual image and the second image, wherein the second super resolution is higher than the first super resolution; at 308, determining, by the second network, a second residual image based on the third image and the first image; at 310, generating, by a third network, a fourth image of third super resolution based on the second residual image and the third image, wherein the third super resolution is higher than the second super resolution; at 312, determining whether the third super resolution of the fourth image reaches a desired resolution; if yes, at 314, stopping the iteration; and if no, at 316, continuing iteratively performing steps 308-312 until the output of 312 is yes, i.e., until the resolution of the generated super resolution image reaches the desired resolution.

By iteratively generating an ith super resolution image (i.e., an image of super resolution) based on the LR image (i.e., the first image), determining an ith residual image between the ith super resolution image and the LR image, and generating an (i+1)th super resolution image based on the ith super resolution image (i.e., the image of super resolution) and the ith residual image, the resolution of the image can be further improved and the residual be reduced, thereby further improving data fidelity.

In some embodiments, it may be determined after any number of images of super resolution are generated whether the last generated image of super resolution reaches the desired resolution. For example, it may be determined after two images of super resolution are generated whether the image of super resolution reaches the desired resolution, or it may be determined after each time an image of super resolution is generated whether this image of super resolution reaches the desired resolution, or it may be determined after n (n being an arbitrary positive integer) images of super resolution are generated whether the last generated image of super resolution reaches the desired resolution, and there is no limitation herein.

In some embodiments, the determination of whether the resolution of the generated image of super resolution reaches the desired resolution may be performed intuitively by the human eye or by comparing the resolution of the generated image of super resolution with threshold resolution with the aid of a machine detection, and there is no limitation herein.

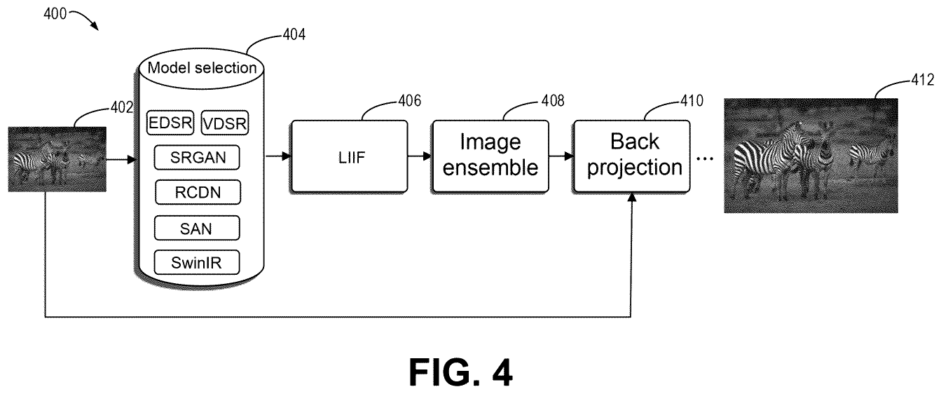

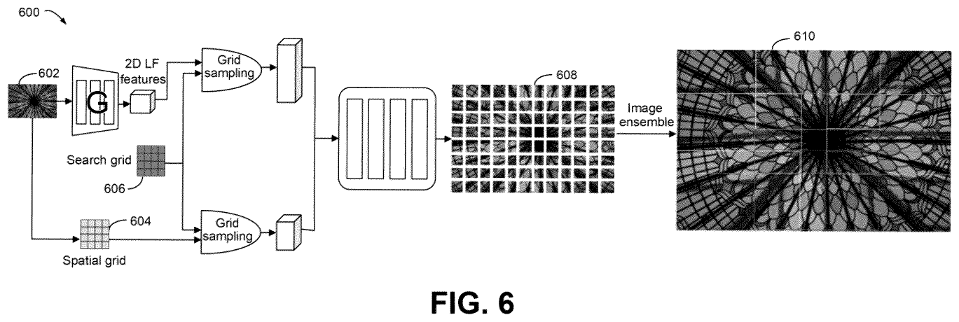

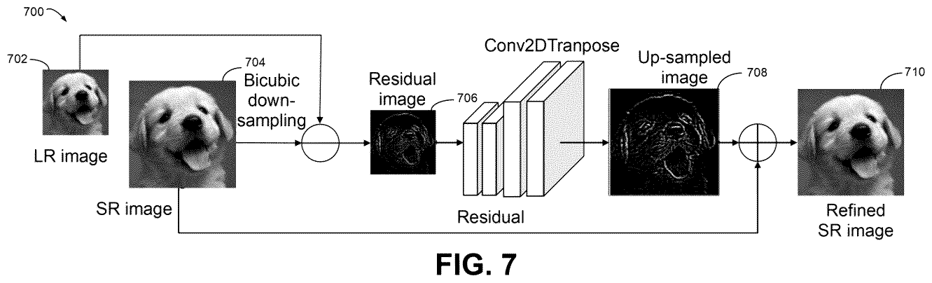

FIG. 4 is a schematic diagram of a cascaded back projection network (CBPN) 400 according to some embodiments of the present disclosure. The CBPN 400 shown in FIG. 4 may correspond to any one of the CBPN1 104a-CBPNN 104n in FIG. 1. As shown in FIG. 4, the CBPN 400 may include a model selection module 404, a local implicit image function (LIIF) module 406, an image ensemble module 408, and a back projection module 410. The model selection module 404 may be used to select an appropriate model to process the first image 402, also referred to as an LR image, to obtain a feature map. The LIIF module 406 may be used to generate image patches based on the feature map and search coordinates. The image ensemble module 408 may be used to generate an SR image based on the image patches. The back projection module 410 may be used to generate a residual image based on the SR image and the LR image. The LIIF module 406 and the image ensemble module 408 will be specifically described below with respect to FIG. 6, and the back projection module 410 will be specifically described with respect to FIG. 7.

As shown in FIG. 4, in the model selection module 404 of the CBPN 400, a particular model is selected based on a category of the first image 402 to process the first image to obtain a feature map that includes depth features of the first image. In the LIIF module 406 of the CBPN 400, image patches are generated based on the feature map and a search coordinate grid. In the image ensemble module 408 of the CBPN 400, a second image of first super resolution is generated based on the image patches. In some embodiments, in the back projection module 410 of the CBPN 400, the second image is down-sampled and the first residual image between the down-sampled second image and the first image is determined. Then, via a model selection module and an LIIF of the next CBPN, the first residual image is added to the second image to obtain a third image of second super resolution. It should be understood that the model selection module 404 of the CBPN 400 and the model selection module of the next CBPN may be the same or different, may include the same or different models, and may select the same or different models to process the corresponding images of super resolution. In some embodiments, any number of such iterations may be undergone to obtain a final super resolution image 412. The super resolution image 412 may have a desired resolution.

In some examples, the LR image X corresponding to the first image 402 described above is inputted to the CBPN 400, an appropriate model for feature extraction is selected in the model selection module 404 of the CBPN 400 based on the category of the LR image, and a feature map ƒ(X) is obtained via the model. In some embodiments, in the LIIF module 406 of the CBPN 400, image patches are generated based on the feature map ƒ(X) and a search coordinate grid. In some embodiments, the feature map ƒ(X) is up-sampled in the LIIF module 406. In some embodiments, in the image ensemble module 408 of the CBPN 400, an ith SR image Yi′ is generated based on the image patches. In some embodiments, the image ensemble module 408 is used to learn an overlapping scheme based on image patches for use in complete image reconstruction, so as to obtain the ith SR image Yi′. In some embodiments, in the back projection module 410 of the CBPN 400, the ith SR image Yi′ is down-sampled and a first residual image between the down-sampled SR image Yi′ and the LR image X is determined. In some embodiments, an estimated LR image Xi′ can be obtained by down-sampling the SR image Yi′. In some embodiments, the estimated LR image Xi′ is fed back by the back projection module 410 to the model selection module of the next CBPN for use in feature extraction again. Then, the residual between the estimated SR image Xi′ and the LR image X is added back to the ith SR image Yi′ by the LIIF module of the next CBPN to obtain the (i+1) th SR image Yi+1′.

In some embodiments, generating the image patches based on the feature map and the search coordinate grid includes: generating, in a multilayer perceptron (MLP) layer of the LIIF module, the image patches based on the feature map and the search grid using a continuous function, wherein the image patches are overlapping. In some embodiments, this continuous function may be s=ƒ(z, x_{q}−v), where z is a latent feature vector, x_{q} is a search coordinate value of the second image, and v is a spatial coordinate of the first image.

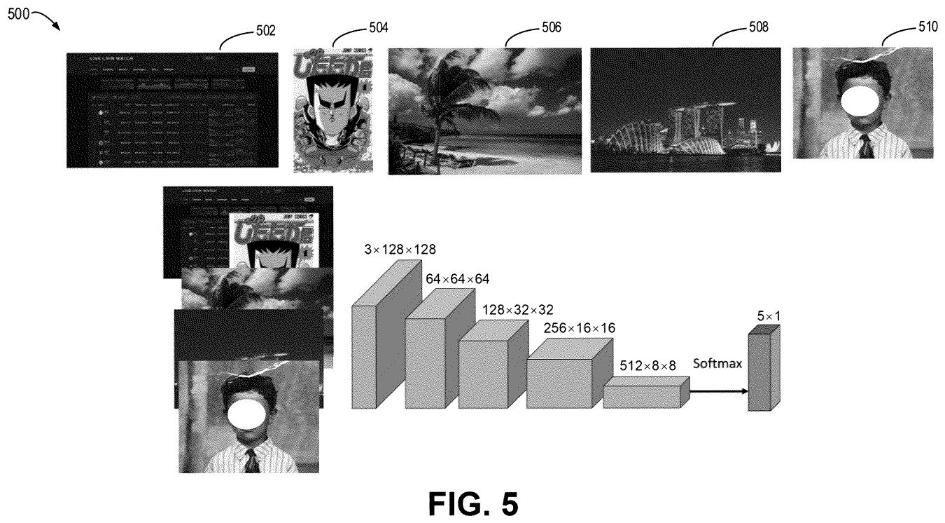

FIG. 5 is a schematic diagram of a model selection module 500 of a cascaded back projection network according to some embodiments of the present disclosure. The model selection module 500 may identify content of the first image to determine the category of the first image; train models in the model selection module separately for corresponding categories of categories; and select, for the first image, a particular model based on the performance of corresponding models in the trained models to process the first image. The model selection module 500 may also be referred to as a model bank. The model bank is a collection of a plurality of pre-trained super resolution models, which may form a domain of experts (DoE) for optimal feature extraction. The disclosed model selection module following the idea of DoE is a multi-modal selection scheme that not only enables automatic model optimization but also provides a user with the freedom of performance checking.

In some embodiments, in the model selection module 500, a particular model is selected based on the category of the first image to process the first image to obtain a feature map for subsequent processing by the LIIF module 406. In some embodiments, selecting a particular model to process the first image includes: identifying content of the first image to determine the category of the first image; training models in the model selection module separately for corresponding categories of categories; and selecting, for the first image, a particular model based on the performance of corresponding models in the trained models to process the first image.

The content of the image/video is domain-specific, for example, based on the content of the image/video, the image may be classified as a text image from a document file containing a large amount of text and numbers, a screen shot from an online conference containing a large amount of digital synthetic patterns, a nature image from a landscape containing a wide color distribution and texture, a cartoon image from comics with a large number of varieties of drawing styles, and so on. Each image domain has a unique pattern that requires specialized super resolution. In some embodiments, the model selection module 500 may identify the content of the LR image to determine the LR image category and select a model from all candidate models that is suitable for the particular LR image category, thereby enabling the training of a particular model using domain-specific data.

In some embodiments, the model selection module 500 may use a multi-classifier to identify the content of the first image based on a classification score. The classification score is illustratively generated as part of an image evaluation method that determines the category of the inputted LR image based on the image content, such as a nature image, a cartoon image, a text image, and the like. The classification score is the output of a multi-classifier, which gives a probability for each category with a higher probability indicating a higher likelihood that the image belongs to that category. In some embodiments, the classification score may be used to select, based on the image content, a super resolution model from the model selection module that best fits the image content.

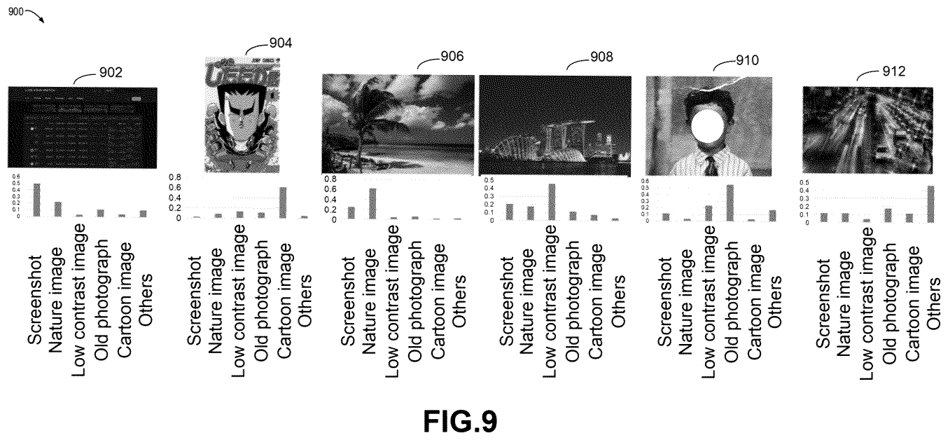

In some embodiments, the model selection module 500 includes a multi-classifier for identifying the content of the inputted image/video. As shown in FIG. 5, six image categories may be considered: a text image (not shown), a screen shot 502, a cartoon image 504, a nature image 506, a low contrast image 508, and an old photograph 510. In some embodiments, more image categories may be considered. In some embodiments, the model selection module 500 may create an autoencoder with a skip connection between the encoder and the decoder for feature sharing. In some embodiments, the output layer of the model selection module 500 may be a softmax function that learns multiclass prediction. The data may be scripted from the Internet for training. As shown in FIG. 5, different categories of images may have different features and the softmax function may be used to classify the inputted LR images. Hereinafter, the performance of the multi-classifier on small datasets will be discussed with reference to the description of FIG. 9.

The model selection module 500 may include various models, for example, a super resolution convolutional neural network (SRCNN), a super depth super resolution (VDSR), an enhanced depth super resolution (EDSR), a robust X-corner detection network (RCDN), Swin transformer-based image restoration (SwinIR), single-image super resolution (SAN), a Laplace pyramid super resolution network (LapSRN), a super resolution residual network (SRResNet), a generative adversarial network (GAN), a super resolution based generative adversarial network (SRGAN), a visual geometry group (VGG), a variational autoencoder (VAE), and the like. Referring back to FIG. 4, where the model selection module 404 may include, for example, an EDSR, a VDSR, an SRGAN, an RCDN, a SAN, a SwinIR, and so on. Their public code is used to train the models on each dataset and obtain the corresponding model files. For N super resolution models trained on the 6 different datasets, a total of 6N models are obtained to form the model selection module.

In some embodiments, the model selection module 500 may determine the performance of corresponding models in the trained models based on non-reference metrics for perceptual estimation. The model selection module 500 may measure the performance of each model on an unknown LR image. The non-reference metrics may be used for perceptual estimation without knowing the baseline true value. Non-reference metrics identify texture and color richness based on nature image patterns and may include both conventional metrics and deep learning based metrics. Examples of non-reference metrics may include perception index (PI) metrics, natural image quality evaluator (NIQE) metrics, and Fréchet inception distance (FID) metrics. These metrics are used to learn a final score for the image quality evaluation. In some embodiments, weights may be assigned to all the metrics or the weights may be adjusted to select one of the metrics.

A non-reference metric is an image quality evaluation method that does not require a reference image, which can estimate the visual quality of an image based on features such as naturalness, clarity, contrast, and other features of the image. In some embodiments, the non-reference metric is used to select, in the absence of a real high resolution image, a super resolution model that is best suited for inputting a low resolution image. The non-reference metric generates a score related to the image quality with a lower score indicating a higher quality image. In some embodiments, the non-reference metric may be used to select, based on the image content, a super resolution model from the model selection module that best fits the image content.

FIG. 6 is a schematic diagram of the LIIF module and the image ensemble module of a CBPN 600 according to some embodiments of the present disclosure. To perform LIIF, a feature vector or feature map is extracted for the LR image 602, image patches 608 are generated by the LIIF module based on the feature vector and a search coordinate grid, and an SR image 610 is generated by the image ensemble module based on the image patches 608. In some embodiments, the image ensemble module may tile the image patches 608 to generate the SR image 610. In some embodiments, the image patches 608 are overlapping image patches.

As shown in FIG. 6, the LIIF is built on implicit arbitrary image super resolution. The LIIF is used to learn feature-based interpolation using a multilayer perceptron (MLP) layer. Given search coordinates and LR feature vectors, a continuous function ƒ shared by all images can be learned, for example, s=ƒ(z, x_{q}−v), where z is the latent feature vector obtained by the encoder, x_{q} is the sampled search coordinate value, and v is the spatial coordinate of the LR image. In some embodiments, in the LIIF, the image is split into spatial coordinates Xhr and a value domain Shr, where Xhr may refer to a coordinate matrix of the image, and Shr may refer to the RGB value corresponding to each coordinate of the image, i.e., a pixel value at the corresponding position. Here, Xhr and Shr correspond to the coordinate matrix of the SR image and the RGB value of each pixel. It should be understood that for the function ƒ above, s belongs to Shr, whereas x_{q} belongs to Xhr. In some embodiments, the LR image is down-sampled as an input and, based on the LIIF, ƒ is made to predict the RGB value corresponding to each pixel of Xhr, i.e., to solve for Shr. In some embodiments, the function ƒ may represent the prediction of the RGB value (i.e., s) of a continuous image at coordinate x_{q} according to a latent feature vector (i.e., z) corresponding to a spatial coordinate v that is closest to the search coordinate value x_{q} (with the proximity of the coordinate being measured using a Euclidean distance) and a relative coordinate (x_{q}−v).

In some embodiments, the LIIF module may be used to generate a high resolution (HR) image. First, the LIIF module may include an encoder that converts the LR image to depth features. The LIIF module may also include an MLP that may take the coordinates and depth features as inputs and output corresponding RGB values. The MLP can realize a continuous representation of the image.

In order to generate high resolution images, the output of the LIIF needs to be searched for on a finer grid. This grid is the search grid, and its size is related to the target resolution. For example, if the image needs to be enlarged by a factor of two, then the size of the search grid is four times the size of the original image. Each point on the search grid is a search coordinate, which represents a pixel position on the high resolution image.

However, it may not be reasonable to directly use the search coordinates and the entire depth feature as inputs to the MLP, as this leads to excessive computation and ignores local information of the image. Therefore, the search coordinates need to be partitioned such that only a small piece of depth feature is used as input for each search coordinate. This small piece of depth feature is an image patch, and its size is related to the neighborhood of the search coordinate. For example, if a 3×3 neighborhood is desired, the size of the image patch is a 3×3 depth feature.

To ensure alignment between search coordinates and image patches, the search coordinates need to be offset somewhat so that each search coordinate lies in the center of an image patch. In this way, each search coordinate and the corresponding image patch can be used as inputs to the MLP to obtain an RGB value on the high resolution image.

In order to improve the generalization capability of the MLP, it is also necessary to overlap the search coordinates somewhat, so that each search coordinate can use several different image patches as inputs. In this way, the diversity of images can be used to increase the training data for the MLP. This degree of overlap can be expressed through a parameter, for example, if it is desired to use 4 different image patches per search coordinate, the degree of overlap is 50%.

In some embodiments, the LIIF of FIG. 6 may include: inputting an LR image and extracting depth features with an encoder; searching for the output of the LIIF on a finer grid to obtain the search grid 606 and search coordinates; partitioning the search coordinates to obtain image patches associated with the depth features; offsetting the search coordinates to align them with the image patches; overlapping the search coordinates so that they use a plurality of image patches as inputs; and using each search coordinate and the corresponding image patch as inputs to the MLP to obtain an RGB value on the high resolution image. In some embodiments, the search grid 606 is partitioned and overlapped to obtain image patches, and these image patches may be overlapping, as each search coordinate may use a plurality of image patches as inputs.

In some embodiments, the spatial grid 604 is a spatial coordinate grid of the LR image, which may be generated by the model. The search grid 606 refers to the search coordinate grid of the HR image or the SR image, which is obtained by random sampling. In some embodiments, the grid sampling in FIG. 6 may input the feature vectors of the LR image (including the 2D LR features and the spatial grid 604) extracted from the spatial grid 604 along with the coordinates in the search grid into the MLP layer in order to learn a continuous function ƒ for use in interpolation and up-sampling.

In some embodiments, in order to achieve large and irregular image up-sampling, the search coordinates of pixels can be randomly sampled to the LIIF for up-sampling. A conventional approach simply passes all search coordinates to the LIIF and combines all RGB pixels to form the final image. In embodiments of the present disclosure, an image patch-based overlapping scheme is used, wherein the search coordinates are partitioned into overlapping image patches, and these overlapping image patches are fed to the LIIF module to obtain overlapping HR image patches 608. Next, these HR image patches 608 are overlapped and tiled together by the image ensemble module to obtain the final HR image. In the final phase as shown in FIG. 6, the overlapping region of the image patches will be the average of all the image patches. In this way, the technical solution of the present disclosure not only can achieve better visual quality, but also can avoid the blocking effect on the boundaries of the image patches.

FIG. 7 is a schematic diagram of a back projection process 700 according to some embodiments of the present disclosure. In some embodiments, the back projection process 700 may be performed in a back projection module. In some embodiments, the back projection process 700 may be performed by both the back projection module of the first network and the model selection module and LIIF model of the second network. In other examples, the back projection process 700 may also be performed jointly by the back projection module of the first network and the model selection module, the LIIF model, and the image ensemble module of the second network.

As shown in FIG. 7, the back projection process 700 may include determining a residual image based on an LR image 702 and an SR image 704 generated based on the LR image. For example, the SR image 704 may be down-sampled, and a residual image 706 between the down-sampled SR image and the LR image may be determined. Alternatively, residual blocks may be obtained based on the residual image 706, and deconvolution may be performed on the residual blocks (e.g., Conv2Dtranspose is performed) to up-sample the residual image 706, thereby obtaining the up-sampled residual image 708. In addition, the SR image 704 is added to the up-sampled residual image 708 to obtain a refined SR image 710. It should be understood that when the LR image 702 corresponds to the first image, the refined SR image 710 may correspond to the third image of the second super resolution. When the LR image 702 corresponds to the LR image X, the SR image 704 may correspond to the ith SR image Yi′, and the refined SR image 710 may correspond to the (i+1)th SR image Yi+1′.

In some embodiments, determining a first residual image based on the first image and the second image may include down-sampling the second image in a back projection module of the first network and determining the first residual image between the down-sampled second image and the first image.

In some embodiments, generating the third image based on the first residual image and the second image therein includes: up-sampling the first residual image in a model selection module, an LIIF module, and an image ensemble module of the second network; and adding the up-sampled first residual image to the second image to generate the third image.

In some embodiments, the back projection module may down-sample the SR image and generate a residual based on the down-sampled SR image and the LR image. This residual represents the error between the SR image and the LR image, i.e., if the SR image is perfect, the residual should be zero. Therefore, it is desired to minimize the residual to improve the quality of the SR image.

In some embodiments, this residual image is fed to the second CBPN, and via the model selection module, the LIIF module, and the image ensemble module of the second CBPN, this residual image is added to the SR image to generate the second SR image. It should be noted that the model selection module of the second CBPN does not directly use the residual image as an input, but first up-samples the residual to the same resolution as the SR image, and then extracts features using the model selection module so that the residual and the SR image are in the same feature space for easy addition. In addition, the model selection module of the second CBPN is not necessarily the same as the model selection module of the first CBPN, which can be adapted and optimized according to the dataset and the device. In some embodiments, the step of generating the residual image 706 and steps prior thereto in FIG. 7 may be performed in the first CBPN, and the steps after generating the residual image 706 may be performed in the second CBPN, where the second CBPN is provided after the first CBPN in the CBPN architecture. In some embodiments, more CBPNs may be designed as needed to further improve the quality of the SR image.

In some embodiments, the back projection process 700 is based on the following assumption: the ideal SR image should have a corresponding estimated LR image that is identical to the original LR image. As shown in FIG. 7, it is desired to minimize the residual between the LR image and the down-sampled SR image corresponding to the estimated LR image, thereby making the SR image closer to the baseline true value. As described above, it is desired to maximize the fidelity of the data in the super resolution image. That is, by minimizing the distance between the LR and down-sampled SR images, the SR image is forced to be constrained to the same space as the LR image.

In the CBPN according to the present disclosure, a back projection mechanism is used to estimate the ith residual between the ith SR and the LR. The residual is added by another model selection module, LIIF, and image ensemble back to the (i+1) th SR image. In practice, it can be determined according to practical needs how many back projection phases are to be performed and trained independently for each phase of back projection. We highlight the importance of this design. Each phase of the back projection is independent of the final state. At an edge device, the previous CBPN networks can be inherited for super resolution. The edge device may also develop its own back projection module to train its own dataset. One advantage is that it can adjust the model bias for a specific dataset, which can lead to a better SNR. Also, the back projection module can be transported to or inherited to any system or device, which makes it scalable and cost effective.

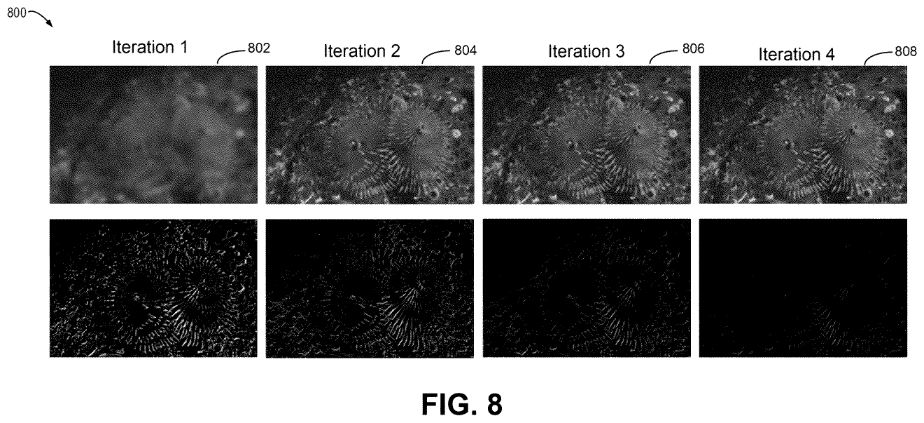

FIG. 8 is a schematic diagram 800 of an image generated by a network architecture for generating a super resolution image according to some embodiments of the present disclosure. FIG. 8 illustrates images obtained from four iterations, with the corresponding SR images obtained after the iterations illustrated in the top row and the corresponding residual images illustrated in the bottom row. It can be understood that the number of iterations corresponds to the number of CBPNs and the number of phases of the back projection module. In FIG. 8, the first iteration 802 corresponds to the following phases: generating a second image of first super resolution based on a first image of first resolution, determining a first residual image based on the first image and the second image, and generating a third image of second super resolution based on the first residual image and the second image. It should be understood that the upper image corresponds to the second image of the first super resolution and that the lower image corresponds to the first residual image. Similarly, the second iteration 804 corresponds to the third image of the second super resolution and a second residual image, the third iteration 806 corresponds to a fourth image of third super resolution and a third residual image, and the fourth iteration 808 corresponds to a fifth image of fourth super resolution and a fourth residual image. In the example of FIG. 8, a four-stage CBPN for generating super resolution images, that is, having a four-stage back projection network, is presented. FIG. 8 illustrates the effect of using multi-stage back projection for super resolution. It can be seen that as the number of stages of back projection modules increases, the image quality gets better and better, and the image quality obtained by using a four-stage back projection module (808) is much better than that obtained by using only one-stage back projection module (802).

FIG. 9 is a schematic diagram 900 of classification scores of a model selection module according to some embodiments of the present disclosure. Specifically, the classification scores in FIG. 9 correspond to the outputs of the multi-classifier of the model selection module. The inventors tested the performance of the multi-classifier for image content recognition. The inventors manually labeled 500 images from the DIV2K and Flcikr2K datasets for training, and selected 60 images for testing, where each category has 10 images. As mentioned above, a classification score can give a probability for each category, with a higher probability indicating a higher likelihood that the image belongs to that category. In FIG. 9, for an image 902, the classification score of the multi-classifier of the model selection module of the present disclosure shows that the image 902 corresponds to a screen shot; for an image 904, the classification score shows that it corresponds to a cartoon image; for an image 906, the classification score shows that it corresponds to a nature image; for an image 908, the classification score shows that it corresponds to a low contrast image; for an image 910, the classification score shows that it corresponds to an old photograph; and for an image 912, the classification score shows that it corresponds to another type of image. It can be seen that the classifier of the model selection module according to embodiments of the present disclosure can correctly identify the content of an image and determine the image category according to the image content.

It should be understood that the method, the device, and the computer program product for generating a super resolution image provided in the present disclosure, by generating, by a first network, a second image having first super resolution higher than first resolution based on a first image of the first resolution, determining a first residual image based on the first image and the second image, and generating, by a second network, a third image having second super resolution higher than the first super resolution based on the second image and the first residual image, can maintain the data fidelity and reduce the signal-to-noise ratio when generating high resolution images, which improves the image quality, thereby improving the user experience. In the architecture of the present disclosure, a back projection scheme is provided in a cascaded manner, so that it can be used for continuous learning, which helps to compress and restore data with a fixed data storage space. Further, the architecture of the present disclosure can be applied to an edge or a cloud for real-time reconstruction. Furthermore, in the present disclosure, following the DoE idea, a multi-modal selection scheme is provided to form a unique model selection module. This not only can enable automatic optimization of the model, but also can provide a user with the freedom of performance checking.

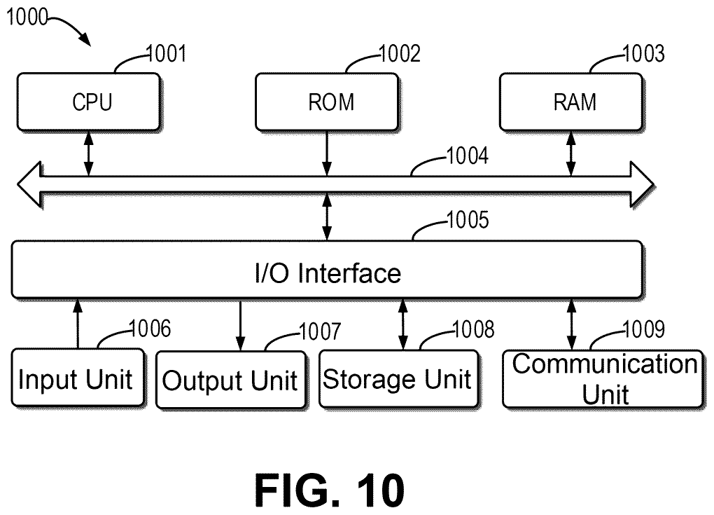

FIG. 10 is a block diagram of an example device 1000 that can be used to implement embodiments of the present disclosure. As shown in the figure, the device 1000 includes a determination unit 1001, illustratively comprising at least one central processing unit (CPU), that may execute various appropriate actions and processing according to computer program instructions stored in a read-only memory (ROM) 1002 or computer program instructions loaded from a storage unit 1008 to a random access memory (RAM) 1003. Various programs and data required for the operation of the device 1000 may also be stored in the RAM 1003. The determination unit 1001, the ROM 1002, and the RAM 1003 are connected to each other through a bus 1004. An input/output (I/O) interface 1005 is also connected to the bus 1004.

A plurality of components in the device 1000 are connected to the I/O interface 1005, including: an input unit 1006, such as a keyboard and a mouse; an output unit 1007, such as various types of displays and speakers; a storage unit 1008, e.g., a magnetic disk and an optical disc; and a communication unit 1009, such as a network card, a modem, and a wireless communication transceiver. The communication unit 1009 allows the device 1000 to exchange information/data with other devices via a computer network, such as the Internet, and/or various telecommunication networks.

The determination unit 1001 may be various general-purpose and/or special-purpose processing components with processing and determination capabilities. Some examples of the determination unit 1001 include, but are not limited to, CPUs, graphics processing units (GPUs), various specialized artificial intelligence (AI) determination chips, various determination units for running machine learning model algorithms, digital signal processors (DSPs), and any appropriate processors, controllers, micro-controllers, etc. The determination unit 1001 performs various methods and processing described above, such as the method 300. For example, in some embodiments, the method 300 may be implemented as a computer software program that is tangibly included in a machine-readable medium, such as the storage unit 1008. In some embodiments, part or all of the computer program may be loaded and/or installed onto the device 1000 via the ROM 1002 and/or the communication unit 1009. When the computer program is loaded to the RAM 1003 and executed by the determination unit 1001, one or more steps of the method 300 described above may be performed. Alternatively, in other embodiments, the determination unit 1001 may be configured to perform the method 300 in any other suitable manners (such as by means of firmware).

The functions described hereinabove may be performed at least in part by one or more hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Complex Programmable Logic Device (CPLD), and the like.

Program code for implementing the method of the present disclosure may be written by using one programming language or any combination of a plurality of programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, RAM, ROM, an erasable programmable read-only memory (EPROM or flash memory), an optical fiber, a portable compact disc read-only memory (CD-ROM), an optical storage device, a magnetic storage device, or any suitable combinations thereof. Additionally, although operations are depicted in a particular order, this should not be construed as an indication that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

What is claimed is:

1. A method for generating a super resolution image, comprising:
generating, by a first network and based on a first image of first resolution, a second image of first super resolution;
determining, by the first network, a first residual image based on the first image and the second image; and
generating, by a second network, a third image of second super resolution based on the first residual image and the second image, wherein the first super resolution is higher than the first resolution and the second super resolution is higher than the first super resolution.

2. The method according to claim 1, further comprising:
determining, by the second network, a second residual image based on the third image and the first image; and
generating, by a third network, a fourth image of third super resolution based on the second residual image and the third image, wherein the third super resolution is higher than the second super resolution.

3. The method according to claim 2, further comprising: determining whether the third) super resolution of the fourth image reaches a desired resolution, and stopping iteration if the third super resolution of the fourth image reaches the desired resolution.

4. The method according to claim 1, wherein generating the second image based on the first image comprises:
selecting, in a model selection module of the first network, a particular model based on a category of the first image to process the first image to obtain a feature map;
generating, in a local implicit image function (LIIF) module of the first network, image patches based on the feature map and a search coordinate grid; and
generating, in an image ensemble module of the first network, the second image based on the image patches.

5. The method according to claim 4, wherein selecting the particular model to process the first image comprises:
identifying content of the first image to determine the category of the first image; and
training models in the model selection module separately for corresponding categories of images; and
selecting, for the first image, the particular model based on performance of corresponding models in the trained models to process the first image.

6. The method according to claim 5,
wherein a multi-classifier of the model selection module is used to identify the content of the first image based on a classification score to determine the category of the first image; and
wherein the performance of the corresponding models in the trained models is determined based on non-reference metrics for perceptual estimation.

7. The method according to claim 4, wherein generating the image patches based on the feature map and the search coordinate grid comprises:
generating, in a multilayer perceptron (MLP) layer of the LIIF module, the image patches based on the feature map and the search grid using a continuous function, wherein the image patches are overlapping.

8. The method according to claim 1, wherein determining the first residual image based on the first image and the second image comprises:
down-sampling the second image in a back projection module of the first network; and
determining the first residual image between the down-sampled second image and the first image.

9. The method according to claim 8, wherein generating the third image based on the first residual image and the second image comprises:
up-sampling the first residual image in a model selection module, an LIIF module, and an image ensemble module of the second network; and
adding the up-sampled first residual image to the second image to generate the third image.

10. The method according to claim 1, wherein the first image comprises a static image or an image frame extracted from a motion video, and wherein the first network is provided on an edge device or a cloud.

11. An electronic device, comprising:
at least one processor; and
a memory coupled to the at least one processor and having instructions stored therein, wherein the instructions, when executed by the at least one processor, cause the electronic device to perform actions comprising:
generating, by a first network and based on a first image of first resolution, a second image of first super resolution;
determining, by the first network, a first residual image based on the first image and the second image; and
generating, by a second network, a third image of second super resolution based on the first residual image and the second image, wherein the first super resolution is higher than the first resolution and the second super resolution is higher than the first super resolution.

12. The electronic device according to claim 11, wherein the actions further comprise:
determining, by the second network, a second residual image based on the third image and the first image; and
generating, by a third network, a fourth image of third super resolution based on the second residual image and the third image, wherein the third super resolution is higher than the second super resolution.

13. The electronic device according to claim 12, wherein the actions further comprise: determining whether the third super resolution of the fourth image reaches a desired resolution, and stopping iteration if the third super resolution of the fourth image reaches the desired resolution.

14. The electronic device according to claim 11, wherein generating the second image based on the first image comprises:
selecting, in a model selection module of the first network, a particular model based on a category of the first image to process the first image to obtain a feature map;
generating, in a local implicit image function (LIIF) module of the first network, image patches based on the feature map and a search coordinate grid; and
generating, in an image ensemble module of the first network, the second image based on the image patches.

15. The electronic device according to claim 14, wherein selecting the particular model to process the first image comprises:
identifying content of the first image to determine the category of the first image; and
training models in the model selection module separately for corresponding categories of images; and
selecting, for the first image, the particular model based on performance of corresponding models in the trained models to process the first image.

16. The electronic device according to claim 15,
wherein the model selection module comprises a multi-classifier which identifies the content of the first image based on a classification score to determine the category of the first image; and
wherein the model selection module determines the performance of the corresponding models in the trained models based on non-reference metrics for perceptual estimation.

17. The electronic device according to claim 14, wherein generating the image patches based on the feature map and the search coordinate grid comprises:
generating, in a multilayer perceptron (MLP) layer of the LIIF module, the image patches based on the feature map and the search grid using a continuous function, wherein the image patches are overlapping.

18. The electronic device according to claim 11, wherein determining the first residual image based on the first image and the second image comprises:
down-sampling the second image in a back projection module of the first network; and
determining the first residual image between the down-sampled second image and the first image.

19. The electronic device according to claim 18, wherein generating the third image based on the first residual image and the second image comprises:
up-sampling the first residual image in a model selection module, an LIIF module, and an image ensemble module of the second network; and
adding the up-sampled first residual image to the second image to generate the third image.

20. A computer program product, the computer program product being tangibly stored on a non-transitory computer-readable medium and comprising machine-executable instructions, wherein the machine-executable instructions, when executed by a machine, cause the machine to perform actions comprising:
generating, by a first network and based on a first image of first resolution, a second image of first super resolution;
determining, by the first network, a first residual image based on the first image and the second image; and
generating, by a second network, a third image of second super resolution based on the first residual image and the second image, wherein the first super resolution is higher than the first resolution and the second super resolution is higher than the first super resolution.
